(19) United States
(12) Patent Application Publication
(10) Pub. No.: US 2003/0051156 A1
(43) Pub. Date: Mar. 13, 2003

(54) Delivering, storing and retrieving secured digital content for untethered usage

(76) Inventors: Ravi Razdan, Solama Beach, CA (US); Jonathan Peter Hughes, San Diego, CA (US)

Correspondence Address: STREAMTONE, INC, 2683 VIA DE LA VALLE, G-427, DELMAR, CA, 92014, US

(21) Appl. No.: 09/948,696

(22) Filed: Sep. 10, 2001

(51) Int. Cl. H04K 1/00

(52) U.S. Cl. 713/201

(57) ABSTRACT

An mechanism to provide untethered client side access to copyrighted content in order to maintain the digital rights associated with that particular content and service. This client also provides a mechanism to deliver multiple content items requested via a single transaction and distributed via various distribution points. Also provides a mechanism to dynamically mange key stores and digital rights on permanent and transient access devices. The client also provides ability to add digital content at the time of purchase to third party locker services other than the retailer, and to secure memory devices.

### FIELD OF INVENTION

The current invention relates to metered and fair use usage of copyrighted content and services via networks and appliances.

### BACKGROUND OF THE INVENTION

With the growth of Web securing of copyrighted digital content has become of paramount importance. Digital Rights Management (DRM) and encryption techniques have tried to address these concerns of copyright holders. But the current techniques either results in solutions that are easily circumvented or unfairly limit the consumers fair rights to an arbitrary number of devices. Also such DRMs do not allow consumer allow consumer flexibility anytime anywhere use of content using any access device, network based web services and storage. Content from multiple distributors can only be procured by multiple transactions.

This invention describes mechanism to request contents services from multiple distributors and service provider with one single client request. The current invention provides flexible fair, any time, anywhere usage of copyrighted content while protecting rights of copyright holders. This includes usage with storage locker services, secure memory cards and wireless devices.

### BRIEF SUMMARY OF INVENTION

The invention describes a dynamic rights management and content security system allowing for a flexible fair use system with multiple consumer devices including, PCs, appliances, personal entertainment systems, wireless, music lockers and network storage systems.

A mechanism is described to allow multiple installations of secure content, distribution of content from multiple distribution points in a single transaction, real time addition of content to a music locker service, storing encrypted content on a secure removable memory chip with simultaneous metering of such usage.

Further objects and advantages of my invention will become apparent from a consideration of the drawings and ensuing description.

### BRIEF DESCRIPTION OF THE SEVERAL VIEWS OF THE DRAWING

FIG. 1—System Architecture

FIG. 2—Multiple Content Delivery

FIG. 3—Distributed System Architecture

### DETAILED DESCRIPTION OF THE INVENTION

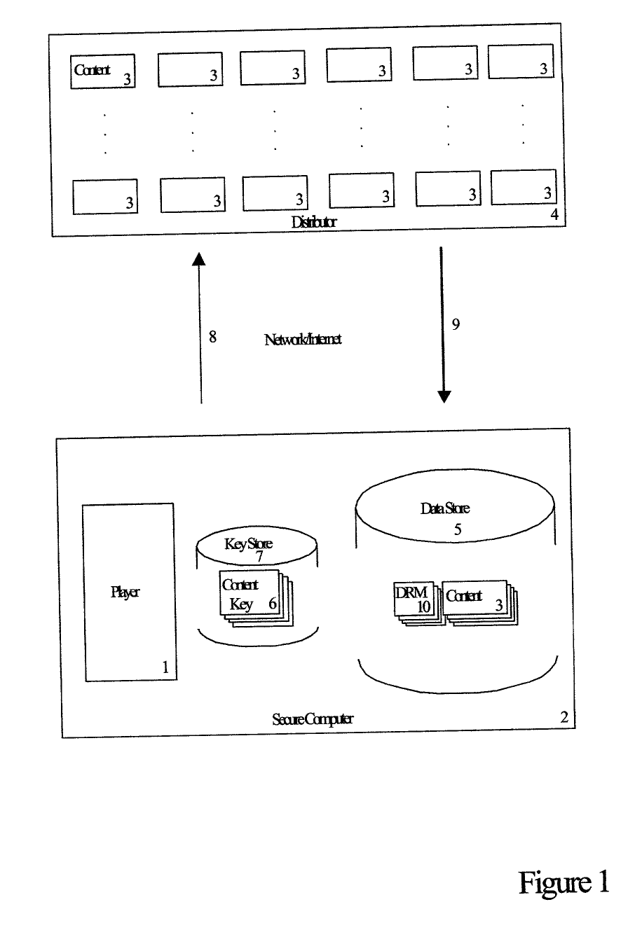

The invention comprises of a piece of software (1) resident on the user's computer (2) that is responsible for requesting and receiving secured digital content (3) from content distributors (4) and provides a means of utilizing that content (the player). For example in the case where the content (3) being acquired and held is music then the software is able to play that music for the user. FIG. 1 identifies the primary components in this invention.

A player (1) has a unique identifier, typically a large random number. In the preferred embodiment this number is the public portion of a private/public key pair generated on a one off basis by the player the first time it is run.

The player has access to a storage system (5) where received digital content (3) is stored. For the content (3) to be stored securely it must be encrypted using an encryption key (6). In the preferred embodiment of this invention the Rijndael encryption system is used. One key (6) may be used for the entire collection of stored data or one key (6) per piece of content (3) may be used.

The Rijndael key(s) (6) are stored in a keystore (7) which is itself encrypted using a key derived via a one way hashing algorithm from the player's private key and certain computer system information which is guaranteed to be unique to that system such as the physical ethernet addresses of any network cards, the serial number of any disk drives or other interface cards. The use of a keystore key prevents the user making a direct copy of the keystore (7) and content storage system (5), and sharing it.

When a request (8) for delivery of content (3) is made, the player (1) identifies itself to the distributor (4) providing the content using the unique player identifier. In response (9) the distributor (4) provides the requested content (3) which the player records into the storage system (5) and encrypts with a key (6) from the keystore (7).

If the content (3) being delivered is sensitive then it maybe encrypted using an appropriate key (6) which can also be sent as part of the transaction (8,9). To ensure that the decryption key (6) itself isn't seen it can be encrypted using the player's unique identifier in the case where that identifier is a valid public key. The content (3) can then be stored directly into the storage system (5) and the decryption key (6) stored (encrypted) into the keystore (7).

In order to utilize the stored secured digital content (3) the player (1) must retrieve the appropriate key (6) from the keystore (7) by first decrypting the keystore (7) with the keystore's key.

Once the appropriate key (6) has been obtained it can be used to decrypt the secured content (3) from the storage system (5).

In the preferred embodiment the storage system (5) together with the keystore (7) is also used to store data (10) controlling what the digital content (3) may be utilized for. Such controlling data (10) can be used to determine: how many times the data can be accessed, how many times it can be copied or moved, whether it is allowed to be modified, whether it can be deleted from the store, how long the user is able to access the data, how many concurrent uses of the data are allowed.

In the situation where a player (1) is being used to content (3) to a mobile device (the mobile device possessing a public/private key pair), the content is transferred to the device in its encrypted state. The content key (6) obtained from the keystore (7) is also loaded onto the mobile device and is encrypted with the mobile device's public key. This allows the device to utilize the content but prevents the user from copying the devices memory since the user does not have access to the device's private key.

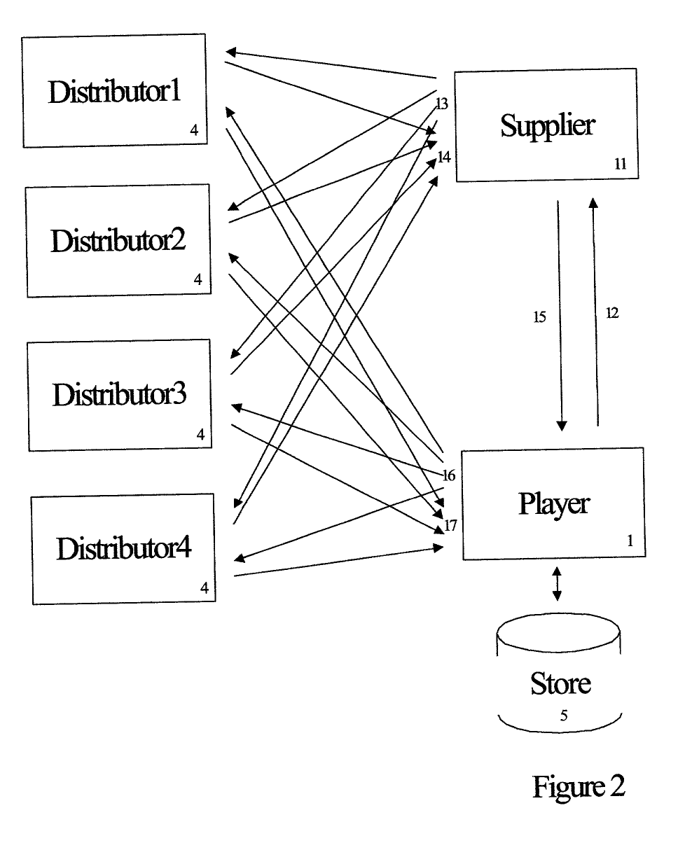

In the preferred embodiment (see FIG. 2) the delivery process (8,9) is extended to allow for the delivery of multiple pieces of content from a variety of distribution locations (the distributors (4)) through an aggregation point (the supplier (11)).

In this instance the player (1) contacts the supplier (11) directly or via a intermediate party and provides a list (12) of the content it is requesting together with its unique player identification (so that logging and billing can be performed). the supplier (11) then contacts the distributors (4) and notifies then of the content (3) that is being requested (13) of them together with the player's unique identifier. In return the distributors provide a list (14) of locations that they will make the content (3) available to the player (1) at. The supplier (11) aggregates these responses and provides them (15) to the player (1).

The player (1) then contacts each distributor (4) and provides its unique player identification and the distributor (4) in turn provides (17) the digital content (3) to the player (1). The content (3) may be provided encrypted or otherwise as described previously.

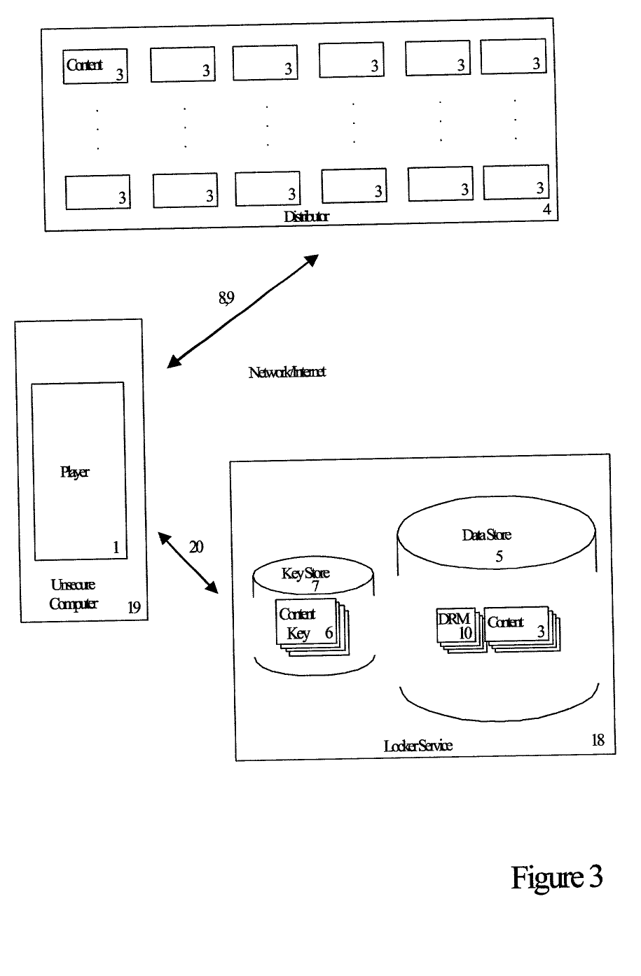

The invention as described so far handles the situation where the user is in full control of their computer (2) and its storage (5). An additional embodiment (see FIG. 3) is described that allows the user to utilize a centralized storage mechanism hosted by some third party (a data locker (18)) and access the content (3) stored there from any computer (19) that can access that locker (18). In this instance the keystore (7) is also held at the locker service (18) and the keystore key is now derived via a secure authentication mechanism (for example password or separate keyholder system) that the user uses to identify themselves since it is not appropriate to utilize computer specific information to generate the keystore key. The player (1) in this instance is modified to handle this authentication mechanism and also to provide removal of the keystore key either after a certain time period or through an explicit user action. The third party guarantees that only one remote connection (20) is allowed at a time per user per keystore (7) stored so as to prevent the user from sharing their authentication credentials and thus sharing the secured content.

While my description contains many specificities, these should not be construed as limitations on the scope of the invention, but rather as an exemplification of some preferred embodiments thereof.

Accordingly, the scope of the invention should be determined not by the embodiment(s) illustrated, but by the appended claims and their legal equivalents.

1. A system for specifying a delivery manifest in a three way relationship comprising of:
client passing the list to the trusted server;
trusted server passing the client selected list to the supplier server; and
supplier server enabling transaction with the distributor server(s).

2. The system in claim 1 were multiple distributors servers deliver the requested content manifest.

3. The system in claim 1 were all communications are done securely.

4. The system in claim 1 were the manifest is a digital product for downloads.

5. The systems in claim 1 were the manifest request services.

6. The systems in claim 1 were the manifest includes both downloads and services.

7. A system for controlling the usage of digital content comprised of:
an encrypted storage system for storing said content; and
an encrypted keystore which holds the keys for said content.

8. The system in 7 were such system is resident on the client device.

9. The system in 7 were such system resides at a third party storage service.

10. The system in 7 were keystore is used to enforce and update usage rights for said content.

11. The system in 7 were access to the keystore is controlled via authentication mechanism comprising of a central keystore or certificate authority utilizing authentication credentials.

12. The system in 11 where the said authentication credentials are a digitally signed certificate.

13. The system in 11 where the said authentication credentials are biometrically derived.

14. The system in 11 were the transaction includes purchasing a service and associated rights are added to the webtop or web based desktop.

15. The system in 11 were just a reference id for the said content is stored.

16. A system for securing content on a mobile device by encrypting content stored on said device with a key wherein said key is encrypted using a public key generated by said device and the associated private key is only accessible to said device.
